(19) United States
(12) Patent Application Publication
(10) Pub. No.: US 2008/0314018 A1
(43) Pub. Date: Dec. 25, 2008

(54) Operation of internal combustion (IC) engines and gas turbines with concurrently generated oxygen enriched air

(76) Inventor: Subhash Chander, Los Angeles, CA (US)

Correspondence Address: Subhash Chander, 430 S Fuller Ave Apt# 10 K, Los Angeles, CA, 90036, US

(21) Appl. No.: 12/156,913

(22) Filed: Jun. 5, 2008

Related U.S. Application Data
(60) Provisional application No. 60/933,759, filed on Jun. 8, 2007.

(51) Int. Cl. F02B 43/10

(52) U.S. Cl. 60/39.12

(57) ABSTRACT

Internal Combustion (IC) Engines and Gas Turbines are the machines built to convert the chemical energy of fuel into mechanical energy via an exothermic reaction, known as Combustion or rapid oxidation. The combustion involves reaction of constituents of fuel with Oxygen.

As on date, atmospheric air is considered as techno-economically the best source of Oxygen. However, Oxygen is only a small fraction of the air and thus bulk of the air is a burden on the energy conversion process with consequential loss of operating efficiency of the respective equipment.

This Invention entails improvement in operating efficiency of IC Engines and Gas Turbines on enhancing the oxygen contents or Oxygen enrichment of the air supplied to the respective equipment for combustion of the fuel.

This enhancement of Oxygen content or Oxygen enrichment of combustion air is accomplished by addition of Oxygen obtained from an Oxygen Generator. Further, this generator is envisaged to be working concurrently with the IC Engine/Gas Turbine and thus providing the oxygen necessary for the enhancement/enrichment on a concurrent basis.

This invention is relevant to all types of Internal Combustion Engines and Gas Turbines irrespective of the basic design, capacity, type of fuel or any mixture of fuels used, or the purpose to which the equipment is deployed and is expected to improve the efficiency of respective equipments with consequent reduction in their operating cost and environmental pollution.

### CROSS REFERENCE

Provisional Patent Application No. 60/933,759. Filing Date Jun. 8, 2007. Confirmation # 5483 Non-Provisional patent application Ser. No. 12/156,913. Filing Date Jun. 5, 2008.

### BACKGROUND

Internal Combustion (IC) Engines and Gas Turbines are the machines built to convert the chemical energy of fuel into mechanical energy via an exothermic reaction, known as Combustion or rapid oxidation. The heat energy so produced is absorbed by the resultant/product gases (of the reaction), thus making them to expand. Since this expansion takes place in a confined space, the so expanding gasses cause pressure and thus convert the heat energy into mechanical energy.

Availability of Oxygen is essential for this exothermic reaction to take place. Typically, this oxygen is provided by the atmospheric air, which is drawn in to the combustion chamber; from the atmosphere. Though, use of stored oxygen in pure form or as hydrogen per-oxide or nitrous oxide as an oxidant is also practiced on a limited scale (for example in submarines and racing cars etc.); for all practical purposes, ‘air’ or ‘atmospheric air’ is the source of Oxygen for operation of internal combustion engines and gas turbines.

Air or atmospheric air is a mixture of gases with Oxygen and Nitrogen constituting bulk of it. The typical composition of air is:—

| | Ratio | Ratio |
|---|---|---|
| Component (Symbol) | (by Volume) | (by Weight) |
| Nitrogen (N2) | 78.08% | 75.47% |
| Oxygen (O2) | 20.95% | 23.20% |
| Argon (Ar) | 0.943% | 1.28% |
| Carbon Dioxide (CO2) | 0.03% | 0.05% |
| Other Gasses | By Balance | By Balance |

(Rounded off to two places of decimal)

Practically, Oxygen is the only component of air which supports combustion or the rapid oxidation; which is required to convert the chemical energy into heat energy. Rest of the gases is a sort of burden in operation of the IC Engines and Gas Turbines. This in turn means that any increase in Oxygen content of the input air will improve the efficiency of respective equipment.

### SUMMARY

Utility patent, applied, vide this non-provisional patent application; is for a process titled ‘Operation of Internal Combustion (IC) Engines and Gas Turbines with concurrently generated oxygen enriched air’.

Unique features of this invention are:—
1—The process envisages use of oxygen enriched air i.e. air with Oxygen content higher than that of atmospheric air; to operate IC Engines and Gas Turbines.
2—The usage of oxygen enriched air is on a continuous basis and
3—The oxygen to be used for enrichment of air is concurrently generated (and not drawn from any sort of storage).

This invention is aimed at improving the efficiency of respective equipment with consequent reduction in their operating cost and environmental pollution.

### THE INVENTION

This invention relates to a process to ‘operate Internal Combustion (IC) Engines and Gas Turbines with concurrently generated oxygen enriched air (OEA)’.

The oxygen enriched air (or the OEA) is an air rich in oxygen i.e. an air with oxygen content better than that of atmospheric air.

This Invention entails improvement in operating efficiency of IC Engines and Gas Turbines on enhancing the oxygen contents of the air supplied to the respective equipment for combustion of the fuel. This is a consequence of reduced content of other gasses per unit of oxygen available for combustion, which in turn reduces the operating burden of the respective equipment (IC Engine or Gas Turbine) and hence the improvement in its efficiency.

The enrichment of atmospheric air, in terms of its oxygen content before letting it into the combustion chamber; is accomplished by addition of Oxygen, obtained from an Oxygen Generator.

The Oxygen Generator can either be an integral part of the respective Internal Combustion (IC) Engine/Gas Turbine or an independent unit, but a unique feature of this Oxygen Generator is that it works concurrently with the respective IC Engine or Gas Turbine to provide oxygen for enrichment of air meant for combustion or rapid oxidation of the fuel while operating the respective equipment.

Schematic representation of the process envisaged in this invention is as below:—

| | | |
|---|---|---|
| Oxygen from Oxygen | Combustion or Rapid | Motive Power |
| Generator + | Oxidation in the Combustion | |
| Atmospheric Air → | Chamber of Internal | |
| OEA → | Combustion Engine | |
| Fuel → | or Gas Turbine → | |

As is known, Oxygen Generator is an equipment that generates Oxygen. This Oxygen is mixed with air drawn from the atmosphere in make-up or balancing quantity and thus we get the Oxygen Enriched Air which has Oxygen content better than that of atmospheric air.

This invention intends to use the developments that have taken place in generation of Oxygen gas so as to economize on operating cost and minimize impact on environment. Accordingly, Pressure Swing Absorption (PSA) system for extraction of Oxygen from atmospheric air has been envisaged. Such generators yield about 90% pure Oxygen.

As evident from the schematic representation depicted above, out-put of the oxygen generator is connected to air in-take of the IC Engine/Gas Turbine. The make-up or balancing quantity of air is drawn from the atmosphere through a non-return valve and added to the oxygen available from the oxygen generator. The non-return valve is so positioned that it only allows the entry of atmospheric air into the system and can be fixed either on the shell of oxygen chamber of the oxygen generator or the air in-take assembly. The make-up or balancing air is necessary to permit techno-economic viability of the invention without sacrificing the very concept of using the oxygen enriched air to operate IC Engine/Gas Turbine, (as the oxygen content of resultant air obtained on aforesaid addition will always be higher than that of atmospheric air).

### BENEFITS OF THE INVENTION

The invention is expected to improve the efficiency of Internal Combustion Engines and Gas Turbines with consequent reduction in their operating cost and environmental pollution.

### APPLICABILITY

This invention is relevant to all types of Internal Combustion Engines and Gas Turbines irrespective of the basic design, capacity, type of fuel or any mixture of fuels used, or the purpose to which the equipment is deployed.

A Use of oxygen enriched air, i.e. air with Oxygen content higher than that of atmospheric air; to operate IC Engines and Gas Turbines.

B The usage of oxygen enriched air is on a continuous basis (and not like occasional booster dosing as practiced in racing cars).

C The oxygen being used for enrichment of air is concurrently generated (and not drawn from any sort of storage like bottled oxygen cylinder/tank).

D An Oxygen Generator is provided & operated concurrently with the IC Engine/Gas Turbine to generate the oxygen on concurrent basis so as to comply with the features/claims stated at B & C above.

E The invention is relevant to all types of Internal Combustion Engines and Gas Turbines irrespective of the basic design, capacity, type of fuel or any mixture of fuels used, or the purpose to which the equipment is deployed.
